(19) United States
(12) Patent Application Publication
(10) Pub. No.: US 2019/0349556 A1
(43) Pub. Date: Nov. 14, 2019

(54) PROJECTION SUITABILITY DETECTION SYSTEM, PROJECTION SUITABILITY DETECTION METHOD, AND NON-TRANSITORY MEDIUM

(71) Applicant: SHARP KABUSHIKI KAISHA, Sakai City, Osaka (JP)

(72) Inventors: TAICHI MIYAKE, Sakai City, Osaka (JP); MAKOTO OHTSU, Sakai City, Osaka (JP); TAKUTO ICHIKAWA, Sakai City, Osaka (JP)

(21) Appl. No.: 16/481,599

(22) PCT Filed: Nov. 30, 2017
(86) PCT No.: PCT/JP2017/043143

§ 371 Date: Jul. 29, 2019

(30) Foreign Application Priority Data
Feb. 1, 2017 (JP) 2017-017061

(51) Int. Cl. H04N 9/31; G06T 7/73; G06T 7/00

(52) U.S. Cl. CPC H04N 9/3185; G06T 7/74; G08B 6/00; H04N 9/3194; G06T 7/0002

(57) ABSTRACT

A location on a projection surface where visual information is not projected in a suitable manner is detected, and a result of the detection is outputted. A projection suitability detection system (100), which is an aspect of the present disclosure, detects on the basis of a captured image of an operation target object (OB) whether or not the operation target object (OB) has a projection surface that causes projection distortion and then outputs a result of the detection to an instructor (CR) end.

### TECHNICAL FIELD

The present disclosure relates to projection suitability detection systems, methods, and programs for detecting suitability of projecting content from a projection device onto a projection object.

### BACKGROUND ART

AR (augmented reality) technology has been developed that can display graphics, text, still images, video, and/or other visual information by superimposing such visual information on an image that represents a real space. AR technology is capable of, for example, a superimposed display of an instruction video or like content on a workpiece at a worksite or a superimposed display of a diagnostic image or like content on a patient's body at a medical site.

There are some approaches to AR, including optical see-through, video see-through, and projection techniques. When two or more persons view the same AR information simultaneously, optical see-through and video see-through systems require each person to wear a dedicated device. On the other hand, projection-based AR advantageously allows two or more persons to view the same AR information simultaneously without having to require the persons to wear a dedicated device.

Projection-based AR projects computer-generated or -edited video from a projection device onto an object in a real space in order to display superimposed visual information such as graphics, text, still images, and videos on the object.

Patent Literature 1 discloses a job assisting method that leverages this mechanism. The projection-based AR method projects, as AR content, instruction information fed by a user who gives instructions from a remote location (hereinafter, an “instructor”) for viewing at a worksite by another user who is doing a job at the worksite (hereinafter, a “worker”).

### CITATION LIST

### Patent Literature

Patent Literature 1: WO2016/084151 (Jun. 2, 2016)

### SUMMARY OF INVENTION

### Technical Problem

The job-assisting projection-based AR technology described in Patent Literature 1, however, involves the use of an image capturing device that is typically located at a distance from the worker. The instructor, who is viewing a video captured by the image capturing device, has a different point of view from the worker. The method described in Patent Literature 1, therefore, is short of considering the tilts and surface irregularities of the workpiece in displaying the video captured by the image capturing device. If the instructor gives a job instruction in such a system, the worker, who is viewing projected AR content (hereinafter, “projection content” or “visual information”), may recognize the workpiece having a different shape from the shape given by the instructor in a job instruction.

The present disclosure has been made in view of these problems and has an object to provide a projection suitability detection system, method, and program that involve the use of a projection device that projects visual information on a projection object in such a manner as to detect a location where visual information is not projected in a suitable manner from the instructor's point of view and the worker's point of view on the basis of the topographical features of the surface of the workpiece and notify a result of the detection to the instructor.

### Solution to Problem

To address the problems, the present disclosure, in an aspect thereof, is directed to a projection suitability detection system including: a first terminal including an instruction device that receives designation of a position in a captured image of an object; and a second terminal including a projection device that projects visual information onto a projection surface of the object, the projection surface corresponding to the designated position in the captured image, the first terminal and the second terminal being separated by such a distance that the first terminal and the second terminal can communicate with each other, the projection suitability detection system further including a detection unit that detects based on the captured image whether or not the projection surface causes projection distortion, wherein the first terminal includes an output unit that outputs a result of detection performed by the detection unit.

To address the problems, the present disclosure, in an aspect thereof, is directed to a projection-end terminal separated from an instructor-end terminal by such a distance that the projection-end terminal can communicate with the instructor-end terminal, the instructor-end terminal including an instruction device that receives designation of a position in a captured image of an object, the projection-end terminal including a projection device that projects visual information onto a projection surface of the object, the projection surface corresponding to the designated position in the captured image, the projection-end terminal including a detection unit that detects based on the captured image whether or not the projection surface causes projection distortion, wherein the projection-end terminal transmits a result of detection performed by the detection unit to the instructor-end terminal.

To address the problems, the present disclosure, in an aspect thereof, is directed to an instructor-end terminal including an instruction device that receives designation of a position in a captured image of an object, the instructor-end terminal being separated from a projection-end terminal by such a distance that the instructor-end terminal can communicate with the projection-end terminal, the projection-end terminal including a projection device that projects visual information onto a projection surface of the object, the projection surface corresponding to the designated position in the captured image, the instructor-end terminal including: a detection unit that detects based on the captured image whether or not the projection surface causes projection distortion; and an output unit that outputs a result of detection performed by the detection unit.

To address the problems, the present disclosure, in an aspect thereof, is directed to a method of detecting projection suitability performed by a projection suitability detection system including: a first terminal including an instruction device that receives designation of a position in a captured image of an object; and a second terminal including a projection device that projects visual information onto a projection surface of the object, the projection surface corresponding to the designated position in the captured image, the first terminal and the second terminal being separated by such a distance that the first terminal and the second terminal can communicate with each other, the method including: the detection step of detecting based on the captured image whether or not the projection surface causes projection distortion; and the output step of the first terminal outputting a result of detection performed in the detection step.

To address the problems, the present disclosure, in an aspect thereof, is directed to a projection suitability detection program causing a computer to operate as units included in the projection suitability detection system configured as above, the program causing the computer to operate as the detection unit and the output unit.

### Advantageous Effects of Invention

The present disclosure, in an aspect thereof, detects a location where visual information (projection content) is not projected onto a projection object in a suitable manner and outputs a result of the detection, so that the instructor can receive a notification with such contents.

### BRIEF DESCRIPTION OF DRAWINGS

FIG. 1 is an illustration of a job-assisting projection-based AR system, which is a projection suitability detection system in accordance with an embodiment of the present disclosure, in actual use.

FIG. 2 is an illustration of a configuration of a projection suitability detection system in accordance with an embodiment of the present disclosure.

FIG. 3 is a functional block diagram of a projection suitability detection system in accordance with an embodiment of the present disclosure.

FIG. 4 is a block diagram of an example configuration of a worker-end device and an instruction device in a projection suitability detection system in accordance with an embodiment of the present disclosure.

FIG. 5 is a block diagram of a configuration of a surface inferring unit in a projection suitability detection system in accordance with an embodiment of the present disclosure.

FIG. 6 is an illustration of an example of how a projection suitability detection system in accordance with an embodiment of the present disclosure notifies projection distortion.

FIG. 7 is a flow chart of a process of transmitting a result of detection of projection distortion performed by a worker-end device and transmitting encoded video in a projection suitability detection system in accordance with an embodiment of the present disclosure.

FIG. 8 is a flow chart of a process of a worker-end device receiving information from an instruction device in a projection suitability detection system in accordance with an embodiment of the present disclosure.

FIG. 9 is a flow chart of a process performed by an instruction device in a projection suitability detection system in accordance with an embodiment of the present disclosure.

FIG. 10 is an illustration of a job-assisting projection-based AR system, which is a projection suitability detection system in accordance with another embodiment of the present disclosure, in actual use.

FIG. 11 is a flow chart of a process performed by an instruction device in a projection suitability detection system in accordance with another embodiment of the present disclosure.

FIG. 12 is an illustration of a job-assisting projection-based AR system, which is a projection suitability detection system in accordance with another embodiment of the present disclosure, in actual use.

FIG. 13 is a block diagram showing some functional blocks in a projection suitability detection system in accordance with another embodiment of the present disclosure.

FIG. 14 is an illustration of a job-assisting projection-based AR system, which is a projection suitability detection system in accordance with another embodiment of the present disclosure, in actual use.

FIG. 15 is a flow chart of a process performed by an instruction device in a projection suitability detection system in accordance with an embodiment of the present disclosure.

FIG. 16 is an illustration of a part of a process performed by the instruction device shown in FIG. 15.

### DESCRIPTION OF EMBODIMENTS

### Embodiment 1

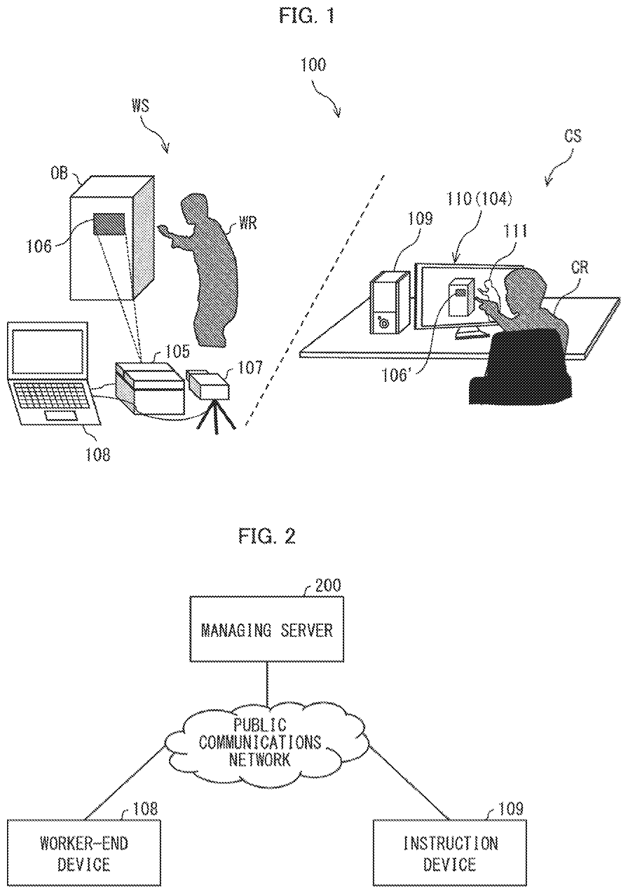

The following will describe a projection suitability detection system in accordance with an embodiment of the present disclosure with reference to FIGS. 1 to 9.

Overview of projection suitability detection system 100 and usage thereof.

FIG. 1 is an illustration of an example usage of a projection suitability detection system 100 in accordance with present Embodiment 1.

The example in FIG. 1 represents a worksite WS and an instruction room CS, showing a worker WR who is at the worksite WS being given job instructions related to an operation target object OB by an instructor CR who is in the instruction room CS.

Using a projection device 105 located at the worksite WS, the instructor CR can display projection content 106 that represents instructions by projecting the projection content 106 onto a specific position on the operation target object OB. The worker WR can thus work watching the projection content 106 being projected. Simultaneously, the worksite WS is videoed on an image capturing device 107 that is located at the worksite WS, so that the instructor CR can remotely observe the ongoing work.

The projection suitability detection system 100 in accordance with present Embodiment 1 includes a worker-end device 108 (second terminal) and an instruction device 109 (first terminal). In the example shown in FIG. 1, the projection suitability detection system 100 operates as described in the following.

First, the worker-end device 108 acquires a video of a region containing the operation target object OB captured by the image capturing device 107 and transmits the acquired video to the instruction device 109. The instruction device 109 then displays the received video on a display device 110. The instructor CR places visual information 106′ that represents instructions on a video 111 of a workpiece being displayed on the display device 110. The instruction device 109 transmits the visual information 106′ to the worker-end device 108. The worker-end device 108, upon receiving the visual information 106′, projects as the projection content 106 the received visual information 106′ onto the operation target object OB via the projection device 105. Incidentally, in the present specification, the equipment located at the worksite WS end of the system including the worker-end device 108 may be referred to as a projection-end terminal, whilst the equipment located at the instruction room CS end of the system including the instruction device 109 may be referred to as an instructor-end terminal.

In this context, the worker-end device 108 and the instruction device 109 need only to be separated by such a distance that the worker-end device 108 and the instruction device 109 can communicate with each other. For example, the worker-end device 108 and the instruction device 109 are linked with each other over a public communications network like the one shown in FIG. 2 (e.g., the Internet) for communications under TCP/IP, UDP, or another set of protocols. The projection suitability detection system 100 may further include a managing server 200 for collectively managing the visual information 106′. When this is actually the case, the managing server 200 is connected to a public communications network. Alternatively, the worker-end device 108 and the instruction device 109 may be linked to a public communications network via a wireless link. When this is actually the case, the wireless link can be established, for example, by using a Wi-Fi® (wireless fidelity) link under the international standards IEEE 802.11 established by the Wi-Fi® Alliance (US industry association). The communications network used here has been so far described as being a public communications network such as the Internet and may alternatively be, for example, a LAN (local area network) which is popularly used in business institutions. Furthermore, the communications network may be a combination of these networks.

Major Components of Projection Suitability Detection System 100

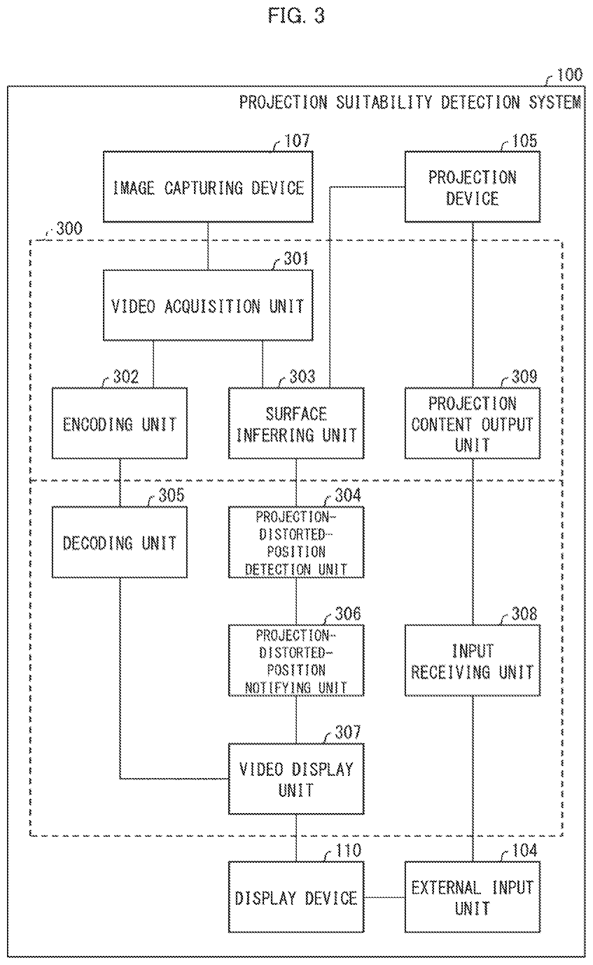

FIG. 3 is a block diagram of major components of the projection suitability detection system 100 in accordance with present Embodiment 1.

Referring to FIG. 3, the projection suitability detection system 100 includes the image capturing device 107, a control unit 300, the projection device 105, the display device 110, and an external input unit 104.

The image capturing device 107 is configured including optical components for capturing an image of an imaging space and an imaging device such as a CMOS (complementary metal oxide semiconductor) or CCDs (charge coupled devices). The image capturing device 107 generates video data for the video 111 on the basis of electric signals obtained by photoelectric conversion in the imaging device.

The control unit 300 includes, as functional blocks, a video acquisition unit 301, an encoding unit 302, a surface inferring unit 303, a projection-distorted-position detection unit 304 (detection unit), a decoding unit 305, a projection-distorted-position notifying unit 306 (output unit), a video display unit 307, an input receiving unit 308, and a projection content output unit 309.

The control unit 300 includes one or more processors. The control unit 300 may include a single processor implementing all the functional blocks or a plurality of processors distributively implementing the functional blocks.

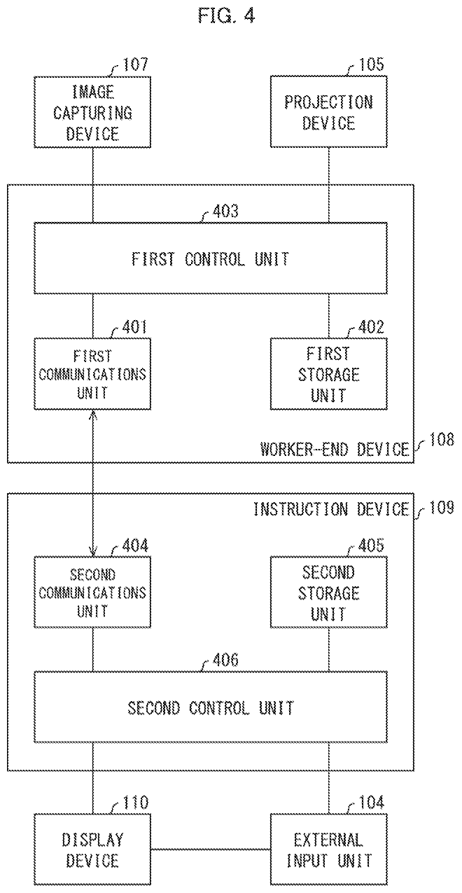

The video acquisition unit 301 acquires the video data (captured image) from the image capturing device 107 and outputs the video data to the encoding unit 302 and the surface inferring unit 303. The video acquisition unit 301 may, in an aspect, output the video data as is acquired, output the video data after subjecting the video data to luminance modulation, noise reduction, and/or other image processing in an image processing unit (not shown), or output both. Alternatively, the video acquisition unit 301 may be configured to send the output video data and parameters such as the focal length used in the imaging to a first storage unit 402 or a second storage unit 405 (detailed later with reference to FIG. 4).

The encoding unit 302 encodes the video signals acquired by the video acquisition unit 301 to compress the video signals (reduce signal quantity) and outputs the resultant, encoded video. The encoding unit 302 may, in an aspect, be constituted at least partly by, for example, an FPGA (field programmable gate array) or an ASIC (application specific integrated circuit). The encoding unit 302 may perform the encoding, for example, under the H.264 international movie compression standards which are suited for encoding of moving images or by any other technique. The projection suitability detection system 100 may not include the encoding unit 302 if no video signal compression is needed for the transfer of video signals between the worker-end device 108 and the instruction device 109 (detailed later).

The surface inferring unit 303 acquires parameters on a plane of the operation target object OB which is a projection object (hereinafter, referred to as plane parameters) and infers information on the surface of the operation target object OB (projection surface). The resultant, inferred information on the surface of the projection object is outputted to the projection-distorted-position detection unit 304. The surface inferring unit 303 may, in an aspect, be constituted at least partly by, for example, an FPGA or an ASIC. Details will be given later on specific methods of acquiring the plane parameters and of inferring information on the surface of the projection object.

The projection-distorted-position detection unit 304 receives a result of the inferring performed by the surface inferring unit 303 and detects projection distortion in a region, of the surface of the operation target object OB, that includes a position where the projection device 105 is to project the projection content 106 (hereinafter, the presence/absence of projection distortion will be referred to as the “result of detection of projection distortion”).

In the present specification, the projection is described as being distorted if upon observing a projection surface onto which visual information is being projected, at least a part of the visual information is not in correct shape or missing and invisible (a phenomenon that may occur when visual information is projected onto a region that includes a dent or a hole). The projection-distorted-position detection unit 304 may, in an aspect, be constituted at least partly by, for example, an FPGA or an ASIC. Details will be given later on methods of acquiring the result of detection of projection distortion.

The decoding unit 305 decodes the encoded video back to the original video signals. The decoding unit 305 may, in an aspect, be constituted at least partly by, for example, an FPGA or an ASIC. The projection suitability detection system 100 may not include the decoding unit 305 if no video signal compression is needed for the transfer of video signals between the worker-end device 108 and the instruction device 109 (detailed later).

The projection-distorted-position notifying unit 306 receives a result of detection performed by the projection-distorted-position detection unit 304 and outputs the result. Specifically, the projection-distorted-position notifying unit 306 generates and outputs notification contents that notify a projection-distorted position. The projection-distorted-position notifying unit 306 may, in an aspect, be constituted at least partly by, for example, an FPGA or an ASIC. Details will be given later on specific methods of generating notification contents.

The video display unit 307 generates, from the video signal output of the decoding unit 305 and the result of detection of projection distortion, a video signal in which the notification contents generated by the projection-distorted-position notifying unit 306 are superimposed on the video signal. The video display unit 307 sends the generated video signal externally to the display device 110. The displayed information may, in an aspect, have any data format. Still images may be of any general-purpose data format including Bitmap and JPEG (joint photographic experts group) formats, whilst moving images may be of any general-purpose data format including AVI (audio video interleave) and FLV (flash video) formats. Alternatively, the displayed information may be of any proprietary data format. As a further alternative, the video display unit 307 may be capable of converting still or moving images from one data format to another. The video display unit 307 may, in an aspect, be constituted at least partly by, for example, an FPGA or an ASIC.

The input receiving unit 308 receives the visual information 106′ entered on the external input unit 104. The input receiving unit 308 may, in an aspect, be constituted at least partly by, for example, an FPGA or an ASIC.

The projection content output unit 309 outputs as the projection content 106 the visual information 106′ received by the input receiving unit 308 externally to the projection device 105. The projection content output unit 309 may, in an aspect, be constituted at least partly by, for example, an FPGA or an ASIC.

The functional blocks described above at least partly constitute the control unit 300.

The projection device 105 may, in an aspect, be constituted at least partly by, for example, a DLP (digital light processing) projector or a liquid crystal projector.

The display device 110 may, in an aspect, be constituted at least partly by, for example, an LCD (liquid crystal display) or an organic EL display device (OELD: organic electroluminescence display).

The external input unit 104 feeds the visual information 106′ in response to a manual operation by the instructor CR. The external input unit 104 may, in an aspect, be constituted at least partly by a mouse, a keyboard, and/or a like device. Alternatively, the display device 110 may include the external input unit 104. As an example, the display device 110 may include a touch panel, so that the instructor CR can carry out a manual operation by touching the display device 110, for example, with his/her finger.

Hardware Configuration of Projection Suitability Detection System 100

FIG. 4 is a block diagram of an example hardware configuration of the projection suitability detection system 100. As described earlier, the projection suitability detection system 100 includes the worker-end device 108 and the instruction device 109 in an example.

The worker-end device 108 includes a first communications unit 401, the first storage unit 402, and a first control unit 403 as shown in FIG. 4.

The first communications unit 401 modifies the encoded video output (data) of the encoding unit 302 in preparation for a transfer (communications) over a network and transmits the modified encoded video to the instruction device 109. The first communications unit 401 also receives the result of detection of projection distortion from the projection-distorted-position detection unit 304 and transmits the result to the instruction device 109. In addition, the first communications unit 401 receives the visual information 106′ from the instruction device 109. The first communications unit 401 may, in an aspect, be constituted at least partly by, for example, an FPGA or an ASIC. The modification of data for the purpose of a transfer over a network may, for example, be an addition of information required for a transfer under TCP/IP, UDP, or another set of protocols. The communications may be performed by any scheme including the schemes described here, so long as a bidirectional channel can be established for mutual data transmission and reception.

The first storage unit 402 stores, for example, internal and external parameters for the image capturing device 107 and the projection device 105, the plane parameters obtained by the surface inferring unit 303, and various data used in image processing. The first storage unit 402 may, in an aspect, be constituted at least partly by, for example, a storage device such as a RAM (random access memory) or a hard disk.

The first control unit 403 controls the entire worker-end device 108. The first control unit 403 is constituted at least partly by, for example, a CPU (central processing unit). The first control unit 403 performs control related to control and instructions for the processes performed by the functional blocks and input/output of data to/from the functional blocks. The first control unit 403 is capable of implementing some or all of the processes performed by the functional blocks in the control unit 300 in FIG. 3.

The worker-end device 108 may include a bus for data exchange between the individual blocks.

The worker-end device 108, the projection device 105, and the image capturing device 107 are, in an aspect, provided as separate devices as shown in FIG. 1. Present Embodiment 1 is not necessarily limited to such an example. In another aspect, the worker-end device, the projection device, and the image capturing device may be housed in a casing and integrated into a single device. Alternatively, a combination of some of these devices may be integrated into a single device.

The instruction device 109 includes a second communications unit 404, the second storage unit 405, and a second control unit 406.

The second communications unit 404 receives the encoded video and a result of the inferring performed by the surface inferring unit 303 from the worker-end device 108. The second communications unit 404 also transmits the visual information 106′ to the worker-end device 108. The second communications unit 404 may, in an aspect, be constituted at least partly by, for example, an FPGA or an ASIC.

The second storage unit 405 stores, for example, parameters needed in detecting projection distortion and various data used in image processing. The second storage unit 405 may, in an aspect, be constituted at least partly by, for example, a storage device such as a RAM (random access memory) or a hard disk.

The second control unit 406 controls the entire instruction device 109. The second control unit 406 is constituted at least partly by, for example, a CPU. The second control unit 406 performs control related to control and instructions for the processes performed by the functional blocks and input/output of data to/from the functional blocks. The second control unit 406 is capable of implementing some or all of the processes performed by the functional blocks in the control unit 300 in FIG. 3.

Similarly to the worker-end device 108, the instruction device 109 may include a bus for data exchange between the individual blocks.

The instruction device 109 and the display device 110 are, in an aspect, provided as separate devices as shown in FIG. 1. The present embodiment is not necessarily limited to such an example. In another aspect, the instruction device and the display device may be configured like a tablet computer housed in a casing.

The first control unit 403 in the worker-end device 108 and the second control unit 406 in the instruction device 109 may distributively implement the processes performed by the functional blocks in the control unit 300 in FIG. 3. For instance, as indicated by broken lines in the control unit 300 in FIG. 3, the first control unit 403 in the worker-end device 108 may implement the processes performed by the video acquisition unit 301, the surface inferring unit 303, and the projection content output unit 309, whilst the second control unit 406 in the instruction device 109 may implement the processes performed by the projection-distorted-position detection unit 304, the projection-distorted-position notifying unit 306, and the video display unit 307. Alternatively, the first control unit 403 in the worker-end device 108 and the second control unit 406 in the instruction device 109 may implement the processes performed by the functional blocks in the control unit 300 in a differently distributed manner.

Processing in Surface Inferring Unit 303

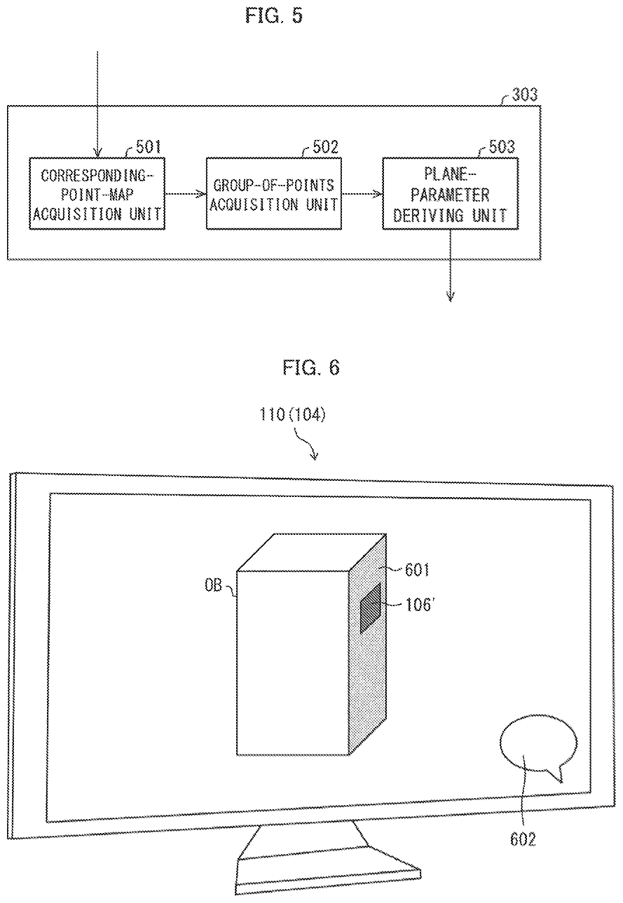

Referring to FIG. 5, a description will be now given of how the surface inferring unit 303 of present Embodiment 1 acquires surface information.

FIG. 5 is a diagram representing a functional block configuration of the surface inferring unit 303.

The surface inferring unit 303 includes a corresponding-point-map acquisition unit 501, a group-of-points acquisition unit 502, and a plane-parameter deriving unit 503 as shown in FIG. 5.

The corresponding-point-map acquisition unit 501 calculates a list of correspondence between the positions of pixels in the video data acquired by the video acquisition unit 301 shown in FIG. 3 and the positions of pixels in the video that will be projected from the projection device 105 (hereinafter, a “corresponding-point map”). The corresponding-point map may be calculated, for example, by coded structured light projection in which a patterned image (reference image) projected from a projection device is captured to calculate the correspondence from the pattern in the captured image. The corresponding-point map is not necessarily calculated by coded structured light projection and may be calculated by any method so long as the method is capable of acquiring correspondence between the positions of pixels in the video data and the positions of pixels in the video that will be projected from the projection device 105.

From the corresponding-point map acquired by the corresponding-point-map acquisition unit 501, the internal and external parameters for the image capturing device 107 and the projection device 105, and the coordinates of the pixels in the video data acquired by the video acquisition unit 301, the group-of-points acquisition unit 502 calculates, on the basis of the principles of a stereo method using the image capturing device 107 as a reference, the three-dimensional coordinates of each pixel in the video data generated by the image capturing device 107. The internal parameters include a focal length and principal point for the image capturing device 107 and the projection device 105. The external parameters include a rotation matrix and translation vector between the image capturing device 107 and the projection device 105. The group-of-points acquisition unit 502 may be capable of directly acquiring the three-dimensional coordinates. For example, the group-of-points acquisition unit 502 may be any device that works based on a TOF (time of flight) technique whereby a distance is measured on the basis of the reflection time of infrared light to and from an imaged subject.

The plane-parameter deriving unit 503 calculates, from the three-dimensional coordinates of the pixels acquired by the group-of-points acquisition unit 502 (hereinafter, the “three-dimensional group of points”), a plane that best fits the three-dimensional group of points. The plane may, in an aspect, be defined in a three-dimensional coordinate system by equation (1) below, where x, y, and z represent respective three-dimensional coordinates of the system.

[Math. 1]

ax+by+cz+d=0 (1)

In equation (1), (a, b, c) is a normal vector of the plane, and d is a distance from the origin of the three-dimensional coordinate system to the plane. Accordingly, the plane can be calculated by calculating the parameters (a, b, c, d) of equation (1).

The plane-parameter deriving unit 503, in an aspect, subjects pixels in a corresponding-point map to N×N masking. The three-dimensional groups of points (x1, y1, z1) to (xN×N, yN×N, zN×N), which correspond to N×N pixels in this masking, satisfy simultaneous equations (2) below. The value of c is fixed to 1 because (a, b, c) is a normal vector, and the magnitude of the vector may be changed without causing any inconvenience.

$$\begin{matrix}[ Math . 2 ] & \\ ( \begin{matrix}{x}_{1} & {y}_{1} & 1 \\ {x}_{2} & {y}_{2} & 1 \\ ⋮ & ⋮ & ⋮ \\ {x}_{N \times N} & {y}_{N \times N} & 1\end{matrix} ) ( \begin{matrix}a \\ b \\ d\end{matrix} ) = ( \begin{matrix}- {z}_{1} \\ - {z}_{2} \\ ⋮ \\ - {z}_{N \times N}\end{matrix} ) & ( 2 )\end{matrix}$$

Now, letting A, p, and B represent the matrices in simultaneous equations (2) as in equations (3) to (5) below, the plane-parameter deriving unit 503 can, in an aspect, calculate the parameters (a, b, c, d) from equation (6) below.

$$\begin{matrix}[ Math . 3 ] & \\ A = ( \begin{matrix}{x}_{1} & {y}_{1} & 1 \\ {x}_{2} & {y}_{2} & 1 \\ ⋮ & ⋮ & ⋮ \\ {x}_{N \times N} & {y}_{N \times N} & 1\end{matrix} ) & ( 3 ) \\ [ Math . 4 ] & \\ p = ( \begin{matrix}a \\ b \\ d\end{matrix} ) & ( 4 ) \\ [ Math . 5 ] & \\ B = ( \begin{matrix}- {z}_{1} \\ - {z}_{2} \\ ⋮ \\ - {z}_{N \times N}\end{matrix} ) & ( 5 ) \\ [ Math . 6 ] & \\ p = {{A}^{- 1} ( {A}^{T} )}^{- 1} {A}^{T} B & ( 6 )\end{matrix}$$

A⁻¹ is an inverse of matrix A, and A^{T} is a transpose of matrix A.

This calculation is performed each time the mask on the corresponding-point map is scanned. As a result, a group of parameters (a, b, 1, d) is outputted to the projection-distorted-position detection unit 304. The subscript i denotes the number of times of masking, and a single set of surface information is obtained in each masking.

Processes Performed by Projection-Distorted-Position Detection Unit 304

The projection-distorted-position detection unit 304 detects the presence/absence of distortion in the projection of the projection content 106 from the point of view of the worker WR with reference to the parameters of the planes calculated by the surface inferring unit 303 (result of inferring).

The projection-distorted-position detection unit 304 acquires a result, Gi, of detection of projection distortion in masking i by using equation (7), where D is a vector representing the projection direction of the projection device 105 and Pᵢ (=(a, b, 1)ᵢ) is the normal vector of the plane obtained in masking i.

$$\begin{matrix}[ Math . 7 ] & \\ abs \{ normalized ( {P}_{i} ) \cdot normalized ( \vec{D} ) \} \{ \begin{matrix}\leq Th ⇒ {G}_{i} = false \\ > Th ⇒ {G}_{i} = true\end{matrix} & ( 7 )\end{matrix}$$

In equation (7), “normalized” is a function that normalizes an input vector, and “abs” is a function that calculates an absolute value. In addition, the symbol “.” represents a scalar product of vectors. Th is a predetermined threshold value and set equal to a real number between 0 and 1.

In equation (7) above, the closer to 1 abs{normalized (Pi)·normalized (D)} becomes, the more squarely the plane calculated in masking i faces the projection direction of the projection device 105, and accordingly the less distorted the projection content is from the point of view of the worker WR. Conversely, the closer to 0 abs{normalized (Pi)·normalized (D)} becomes, the larger tilt the plane calculated in masking i has with respect to the projection direction, and accordingly the more distorted the projection content 106 is from the point of view of the worker WR. This evaluation is made according to whether or not abs{normalized (Pi)·normalized (D)} is less than the predetermined threshold value Th.

Notification Method

Referring to FIG. 6, a description will be given of how the projection-distorted-position notifying unit 306 displays a notification.

FIG. 6 is an illustration of an example of how the projection-distorted-position notifying unit 306 notifies that the projection is distorted. FIG. 6 shows that the operation target object OB has a surface 601 that includes a location where the projection has been evaluated as being distorted, that is, as being improper, according to the result of detection of projection distortion (result of determination of projection suitability).

Upon receiving the result of detection of projection distortion (result of determination of projection suitability) from the projection-distorted-position detection unit 304, the projection-distorted-position notifying unit 306 notifies the instructor CR of the result.

The notification may be done by any method that is capable of notifying that the projection is distorted, that is, the projection is improper. As an example, the location on the surface 601 where the projection is distorted may be displayed filled in with a single color on the basis of the result of detection of projection distortion so that the instructor CR can be notified that his/her instructions will not be accurately projected from the point of view of the worker WR.

Alternatively, if the instructor CR wants the visual information 106′ to be displayed in the projection-distorted position, the projection-distorted-position notifying unit 306 may notify the instructor CR by displaying an overlapping location in a different color.

As a further alternative, the projection-distorted-position notifying unit 306 may notify the instructor CR by displaying, somewhere on the display device, notification contents 602 that the projection will be distorted or by causing the instruction device 109 to vibrate.

The projection-distorted-position notifying unit 306 does not necessarily notify the instructor CR by one of these methods and may notify the instructor CR by any method that is capable of notifying the instructor CR of the presence/absence of projection distortion (projection suitability) or of pixels where the projection will be distorted.

The projection-distorted-position notifying unit 306 needs only to notify the instructor that his/her instructions will not be accurately projected from the point of view of the worker WR and does not necessarily notify projection distortion. The projection-distorted-position notifying unit 306 may however further notify reasons why the instructions will not be accurately projected, that is, presence of projection distortion.

Operation of Projection Suitability Detection System 100 (Projection Suitability Detection Method)

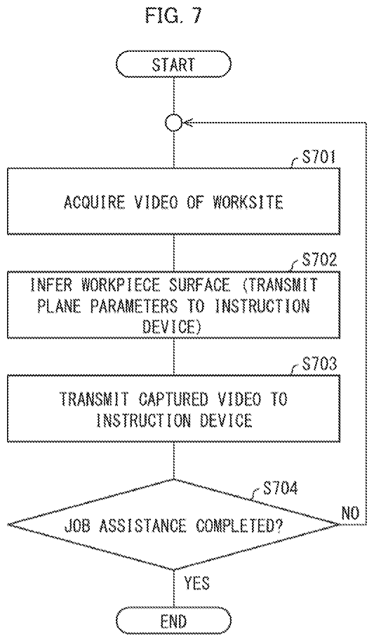

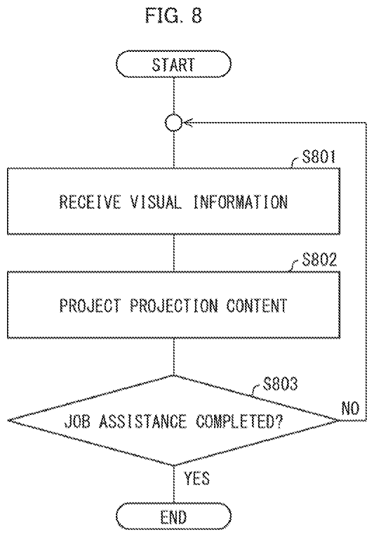

Process flow charts for the worker-end device 108 (FIGS. 1 and 4) will be described with reference to FIGS. 7 and 8. The projection suitability detection system 100 performs the processes represented by the flow charts in FIGS. 7 and 8 in a parallel manner.

FIG. 7 is a flow chart of a process of transmitting plane parameters (result of inferring) and encoded video from the worker-end device 108 to the instruction device 109.

Step S701 is performed first upon activating a projection suitability detection system (A).

In step S701, the video acquisition unit 301 acquires a video of the operation target object OB captured by the image capturing device 107. The process then proceeds to step S702.

In step S702, the surface inferring unit 303 acquires the above-described corresponding-point map. In addition, the surface inferring unit 303 calculates internal and external parameters for the projection device 105 and the image capturing device 107. Furthermore, the surface inferring unit 303 acquires a three-dimensional group of points in a projection region for the projection device 105 by using the corresponding-point map and the internal and external parameters. Lastly, the surface inferring unit 303 acquires plane parameters from the three-dimensional group of points and outputs the plane parameters to the first communications unit 401. The first communications unit 401 transmits the plane parameters to the instruction device 109. The process then proceeds to step S703.

In step S703, the encoding unit 302 encodes the video acquired by the video acquisition unit 301 and outputs the encoded video to the first communications unit 401. The first communications unit 401 transmits the encoded video to the instruction device 109. The process then proceeds to step S704.

In step S704, it is determined whether to end the process. If the process is not to be ended, the process proceeds to step S701. If the process is to be ended, the process is ended all together.

FIG. 8 is a flow chart of a process of the worker-end device 108 receiving information from the instruction device 109.

In step S801, the first communications unit 401 receives the visual information 106′ transmitted from the instruction device 109 and outputs the received visual information to the projection content output unit 309. The process then proceeds to step S802.

In step S802, the projection content output unit 309 outputs the visual information 106′ as the projection content 106 to the projection device 105. The process then proceeds to step S803.

In step S803, it is determined whether to end the process. If the process is not to be ended, the process proceeds to step S801. If the process is to be ended, the process is ended all together.

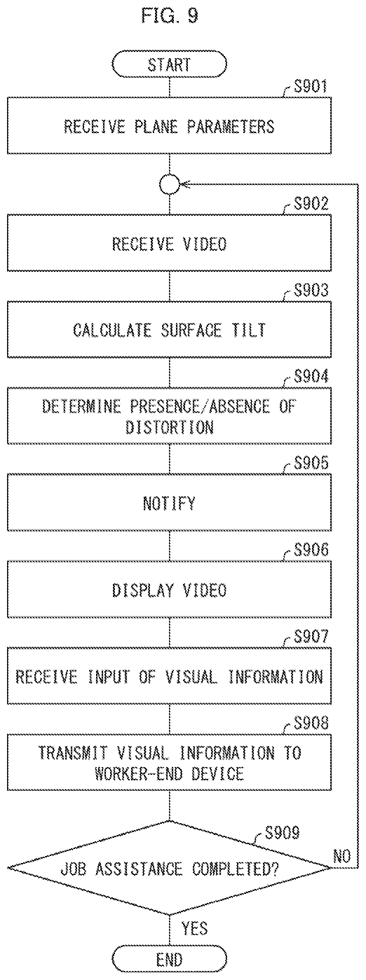

Next, a process flow chart for the instruction device 109 will be described with reference to FIG. 9.

In step S901, the second communications unit 404 receives the plane parameters transmitted from the worker-end device 108 and outputs the received plane parameters to the projection-distorted-position detection unit 304. The process then proceeds to step S902.

In step S902, the second communications unit 404 outputs the encoded video received from the worker-end device 108 to the decoding unit 305. The decoding unit 305 decodes the encoded video and outputs decoded video as the video 111 to the video display unit 307. The process then proceeds to step S903.

In step S903 (detection step), the projection-distorted-position detection unit 304 calculates a tilt (angle) (distortion information) of a surface of a projection object with respect to the projection direction of the projection device 105 by using the plane parameters and information on the projection direction. The process then proceeds to step S904. The “projection direction” in this context is the direction in which the projection device 105 projects an image. The direction in which the projection device 105 projects an image is the same as the direction that is normal to the video projected by the projection device 105. This direction is acquired by the following method. An image-to-image corresponding-point map is first acquired for the projection device 105 and the image capturing device 107. A three-dimensional group of points in a projection region for the projection device 105 is then acquired by using the corresponding-point map and the internal and external parameters. Furthermore, a pixel is selected as the center of the video projected by the projection device 105, and a three-dimensional position is acquired that corresponds to the position of the selected pixel. Letting Pc (Xc, Yc, Zc) represent the acquired three-dimensional position, the vector Pc is equivalent to an optical axis vector (projection direction) that originates at the center of a projection surface for the projection device 105.

In step S904 (detection step), the projection-distorted-position detection unit 304 compares the tilt of a surface with a threshold value to determine whether or not the projection will be distorted and outputs a result of the detection of projection distortion to the projection-distorted-position notifying unit 306. The process then proceeds to step S905.

In step S905 (notification step), the projection-distorted-position notifying unit 306 draws the screen by superimposing notification contents at the corresponding position on the video 111 on the basis of the received result of the detection of projection distortion. The projection-distorted-position notifying unit 306 outputs a result of the drawing to the video display unit 307. The process then proceeds to step S906.

In step S906 (notification step), the video display unit 307 outputs the video containing a superimposed notification of a projection-distorted position to the display device 110. The process then proceeds to step S907. The received video is basically the same as the video captured in acquiring the corresponding-point map. Therefore, a process may be performed whereby all information on surface tilts in the video is calculated and stored in advance and later accessed offline in response to an input of visual information from an instructor, to notify the presence/absence of distortion in an input area.

In step S907, the input receiving unit 308 receives an input from the instructor CR through the external input unit 104 and generates the visual information 106′ at a position designated, by the instructor CR, on the captured image outputted to the video display unit 307. The “position designated on the captured image” refers to a point in the image and a region containing the point (projection surface). The process then proceeds to step S908.

In step S908, the second communications unit 404 transmits the visual information 106′ to the worker-end device 108. The process then proceeds to step S909.

In step S909, it is determined whether to end the process. If the process is not to be ended, the process proceeds to step S902. If the process is to be ended, the process is ended all together.

These processes can detect, from the information on the tilt of a projection surface, a position where the projection on a workpiece is distorted due to a difference between the point-of-view direction of the worker and the point-of-view direction of the instructor. The processes draw the screen by superimposing, on a video of the worksite displayed on a display device, a message indicating where the projection appears distorted. A projection suitability detection system can therefore be provided that notifies the instructor.

Present Embodiment 1 notifies only the instructor. This is however not the only possible implementation of the present disclosure. Present Embodiment 1 may additionally notify the worker. Specifically, when the video display unit 307 outputs a video containing a superimposed notification of a projection-distorted position to the display device 110, the video display unit 307 may output the video additionally to a display unit provided in the worker-end device 108 or cause the projection device 105 to project the superimposed video onto the operation target object OB. This configuration enables the worker to recognize the current situation. The worker may feel uneasy if there are no instructions from the instructor. The configuration can communicate the situation to the worker and hence help relieve the worker's uneasiness by additionally notifying the worker whether the instructor is indeed not issuing any instructions or the instructor wants to send an instruction but is adjusting the position where the instruction is to be projected.

In present Embodiment 1, the instructor is notified, prior to projection, that the projection will be distorted. This is however not the only possible implementation of the present disclosure. Alternatively, the instructor may be notified, regardless of whether or not there is distortion in the projection, that the projection is distorted, in other words, the projection is unsatisfactory, when the projection content is projected onto the operation target object OB.

In present Embodiment 1, the projection content is projected on the operation target object OB which is an object on which the worker works. Alternatively, the projection content may be projected onto an object other than the object on which the worker works so long as the other object is located close to the worker and an image can be projected onto the other object.

### Embodiment 2

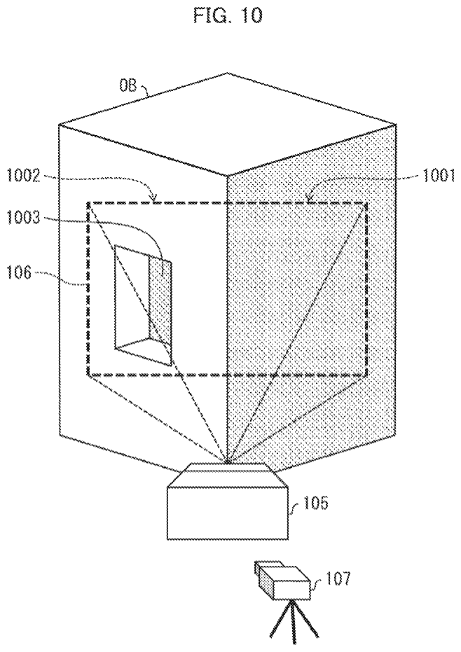

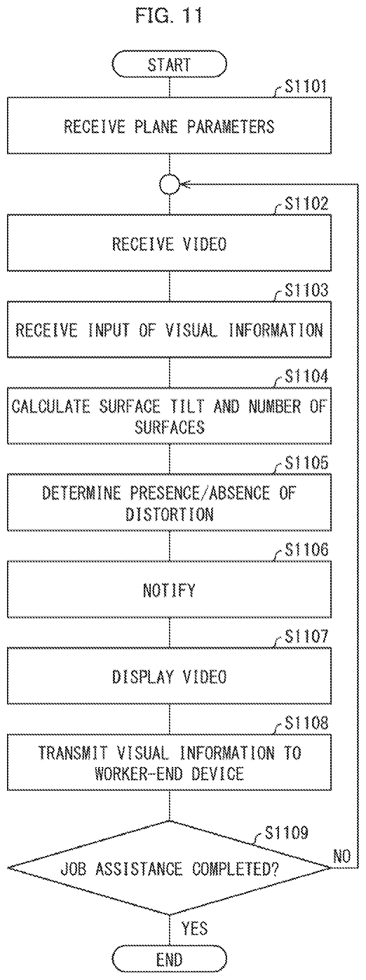

The following will describe another embodiment of the present disclosure with reference to FIGS. 10 and 11. For convenience of description, members of the present embodiment that have the same function as members of the previous embodiment are indicated by the same reference numerals, and description thereof is omitted.

The projection is distorted also when projection content is to be projected across two or more surfaces. An example is illustrated in FIG. 10.

FIG. 10 illustrates an example projection environment. The example in FIG. 10 represents projection content being projected onto two adjacent surfaces 1001 and 1002 that are side faces of the operation target object OB. The projection content appears distorted also in this condition. One of the surfaces 1002 further includes a dent 1003. The projection content appears distorted also when projected onto such a position.

Accordingly, a projection suitability detection system in accordance with present Embodiment 2 notifies the instructor additionally that the projection content is to be projected across two or more surfaces. This is a difference between the projection suitability detection system in accordance with present Embodiment 2 and the projection suitability detection system in accordance with above-described Embodiment 1.

In the process flow for an instruction device 109 in the projection suitability detection system in accordance with above-described Embodiment 1, surface tilts are detected and notified first before an input of visual information from the instructor is awaited. This is by no means intended to limit the scope of the invention, and these processes may be performed in reverse order. Accordingly, the processes will be described as being performed in reverse order in the process flow for the instruction device 109 in the projection suitability detection system in accordance with present Embodiment 2. In summary, the instructor first inputs visual information onto received video before surface tilts in an area for the inputted visual information are calculated. It is then determined on the basis of a result of the calculation whether or not there will occur distortion in the projection, to notify distortion related to the area for the inputted visual information.

The worker-end device 108 performs the same processes in present Embodiment 2 as in Embodiment 1, and description thereof is omitted. Specifically, the surface inferring unit 303 acquires a corresponding-point map, calculates three-dimensional coordinates, and calculates plane parameters in present Embodiment 2 in the same manner as in above-described Embodiment 1.

FIG. 11 is a flow chart of a process performed by an instruction device 109 in the projection suitability detection system in accordance with present Embodiment 2.

In step S1101, the second communications unit 404 receives the plane parameters transmitted from the worker-end device 108 and outputs the received plane parameters to the projection-distorted-position detection unit 304. The process then proceeds to step S1102.

In step S1102, the second communications unit 404 outputs the encoded video received from the worker-end device 108 to the decoding unit 305. The decoding unit 305 decodes the encoded video and outputs decoded video as the video 111 to the video display unit 307. The process then proceeds to step S1103.

In step S1103, the input receiving unit 308 receives an input from the instructor CR through the external input unit 104 and generates the visual information 106′ in the same manner as in step S907 in FIG. 9. The process then proceeds to step S1104.

In step S1104, surface tilts are calculated only in the area for the visual information inputted by the instructor in step S1103. The process then proceeds to step S1105. The step of calculating surface tilts here is essentially the same as step S903 in FIG. 9, but these steps differ in that the step in above-described Embodiment 1 is applied to a single surface for the calculation of the tilt thereof whereas the step in present Embodiment 2 is applied to two or more surfaces for the calculation of the tilts thereof. Specifically, in calculating tilts in an area for visual information (projection object) in present Embodiment 2, it is determined whether or not the projection object has two or more surfaces. If the projection object has two or more surfaces, at least two or more results are obtained in the calculation of the tilt. In other words, it is determined that the projection object extends across two or more surfaces if two or more results are obtained and that the projection object has one surface if a single result is obtained.

In step S1105, in the same manner as in step S904 in FIG. 9, the projection-distorted-position detection unit 304 compares the tilt of a surface with a threshold value to determine whether or not the projection will be distorted. Equation (7), described earlier in Embodiment 1, is used in the comparison. For example, if the projection object extends across two or more surfaces, the visual information inputted by the instructor could be projected across the two or more surfaces upon determining that there will occur no distortion on the individual surfaces (in other words, upon determining that the surfaces are suiable for the projection of projection content). Nevertheless, the projection content can appear distorted in such cases. Accordingly, if the projection extends across two or more surfaces, it is determined that the projection will be distorted (in other words, upon determining that the surfaces are not suitable for the projection of projection content). The projection-distorted-position detection unit 304 outputs a result of the detection of projection distortion to the projection-distorted-position notifying unit 306. The process then proceeds to step S1106.

In step S1106 (notification step), similarly to step S905 in FIG. 9, the projection-distorted-position notifying unit 306 draws the screen by superimposing notification contents at the corresponding position on the video 111 on the basis of the received result of the detection of projection distortion. The projection-distorted-position notifying unit 306 outputs a result of the drawing to the video display unit 307. The process then proceeds to step S1107.

In step S1107 (notification step), the video display unit 307 outputs the video containing a superimposed notification of a projection-distorted position to the display device 110 in the same manner as in step S906 in FIG. 9. The process then proceeds to step S1108.

In step S1108, the second communications unit 404 transmits the visual information 106′ to the worker-end device 108. The process then proceeds to step S1109.

In step S1109, it is determined whether to end the process. If the process is not to be ended, the process proceeds to step S1102. If the process is to be ended, the process is ended all together.

The instructor is notified in the same manner as in Embodiment 1.

### Embodiment 3

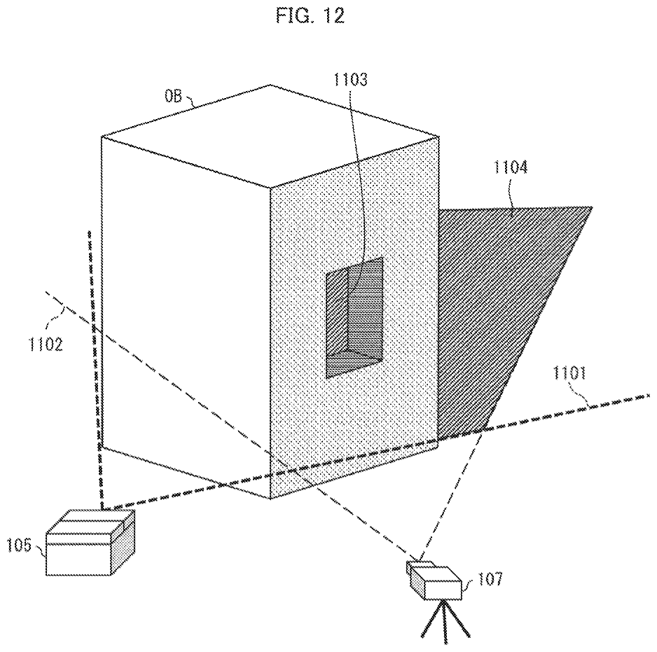

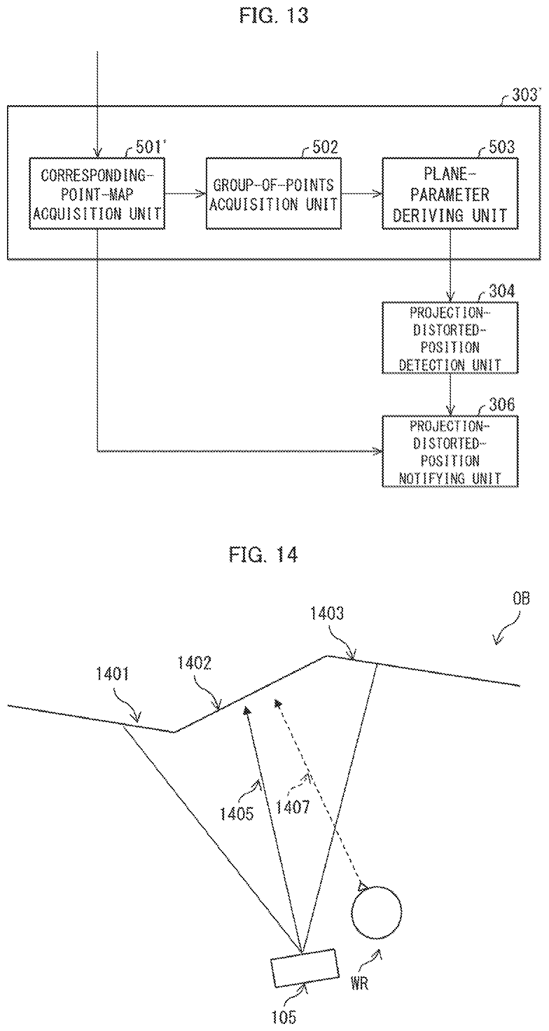

The following will describe another embodiment of the present disclosure with reference to FIGS. 12 and 13. For convenience of description, members of the present embodiment that have the same function as members of a previous embodiment are indicated by the same reference numerals, and description thereof is omitted.

If there occurs an occlusion between the projection device 105 and the image capturing device 107, it is impossible to acquire a corresponding-point map. When this is actually the case, the projection content 106 cannot be accurately recognized from the point of view of the worker WR and from the point of view of the instructor CR.

Accordingly, similarly to the notification contents of above-described Embodiment 1, a projection suitability detection system in accordance with present Embodiment 3 notifies the instructor of a portion for which no corresponding-point map can be acquired.

A description is given of a portion for which no corresponding-point map can be acquired. The projection device 105 has a projection region 1101 that basically differs from an imaging region 1102 for the image capturing device 107 as shown in an example in FIG. 12. Therefore, the light projected from the projection device 105 fails to reach parts of the imaging region 1102 for the image capturing device 107. Locations 1103 and 1104 shown in FIG. 12 are examples of such parts. The location 1103 represents a hole in a side face of the operation target object OB, and projection light fails to reach the hole. The location 1104 represents a region where the three-dimensional shape of the operation target object OB itself blocks projection light, and projection light fails to reach this region.

These locations that projection light fails to reach can be found according to whether or not the corresponding-point-map acquisition unit 501 in the surface inferring unit 303 of above-described Embodiment 1 can acquire corresponding points.

FIG. 13 is a diagram of a part of a configuration of blocks in the projection suitability detection system in accordance with present Embodiment 3.

In the projection suitability detection system in accordance with present Embodiment 3, if a corresponding-point-map acquisition unit 501′ fails to acquire corresponding points in a location, a surface inferring unit 303′ outputs the positions of the pixels in that location to the projection-distorted-position notifying unit 306 (of the instruction device 109) as shown in FIG. 13.

The projection-distorted-position notifying unit 306 receives outputs from the projection-distorted-position detection unit 304 and also receives outputs from the corresponding-point-map acquisition unit 501′ to generate notification contents on a projection-distorted position and the location for which no corresponding-point map can be acquired. The notification contents on the location for which no corresponding-point map can be acquired are generated by the same method as the notification contents on a projection-distorted position.

The projection suitability detection system in accordance with present Embodiment 3 can notify the instructor of a location that projection light fails to reach to project projection content, as well as of the presence/absence of projection distortion.

Present Embodiment 3 describes that no corresponding-point map can be acquired from a location that projection light fails to reach. This is, however, not the only type of location for which no corresponding-point map can be acquired. For instance, no projection can be cast in a location where the surface onto which projection is to be cast is made of a transparent substance like glass. No corresponding-point map can be acquired from such a location. The instructor can be notified of this type of location.

### Embodiment 4

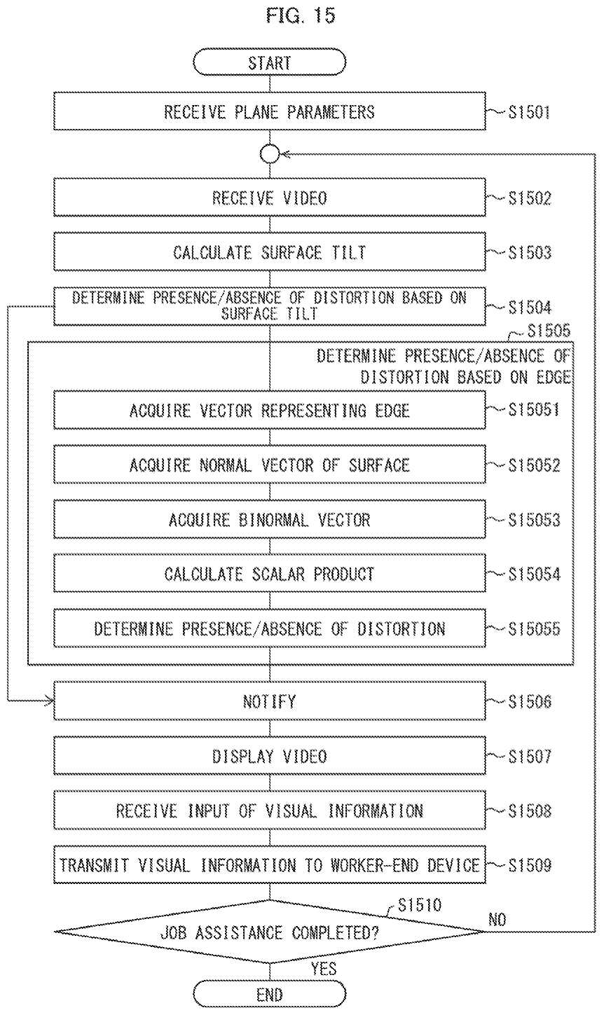

The following will describe another embodiment of the present disclosure with reference to FIGS. 14 and 15. For convenience of description, members of the present embodiment that have the same function as members of a previous embodiment are indicated by the same reference numerals, and description thereof is omitted.

Embodiment 1 above describes an aspect in which visual information is projected onto only one surface, and Embodiment 2 above describes another aspect in which visual information is projected across at least two or more surfaces. Accordingly, present Embodiment 4 describes an aspect in which the same or different visual information is projected onto at least two or more surfaces.

FIG. 14 is an illustration of the aspect described in present Embodiment 4. FIG. 14 shows a projection object that has three surfaces: a surface 1401, a surface 1402, and a surface 1403. FIG. 14 depicts the projection device 105 projecting light parallel to an optical axis 1405 onto this projection object as viewed from above. The worker WR in many cases looks in approximately the same direction (direction 1407) as the optical axis 1405 to recognize projection content. It is assumed that the result of determination of projection suitability indicates no problem according to above-described equation (7) if the instructor CR inputs visual information on any of the surface 1401, the surface 1402, and the surface 1403. In this aspect, although the projected content is actually not distorted, the projected projection content may be invisible depending on the position of the worker WR. For instance, if the worker WR is positioned as shown in FIG. 14, the content projected on the surface 1401 will likely be either invisible because the content is occluded by the surface 1402 or visible, but not accurately recognizable, because the line of sight makes a sharp angle with the surface 1401.

Present Embodiment 4 addresses these problems by, if a section that connects a surface to another surface (hereinafter, “an edge”) makes a ridge, assuming that the projection will be distorted along the edge and notifying that either one of the surfaces may be invisible to the worker.

A specific description will be given of a process flow chart for the instruction device 109 in accordance with present Embodiment 4 with reference to FIG. 15.

In step S1501, the second communications unit 404 receives the plane parameters transmitted from the worker-end device 108 and outputs the received plane parameters to the projection-distorted-position detection unit 304 in the same manner as in step S901 in FIG. 9. The process then proceeds to step S1502.

In step S1502, similarly to step S902 in FIG. 9, the second communications unit 404 outputs the encoded video received from the worker-end device 108 to the decoding unit 305. The decoding unit 305 decodes the encoded video and outputs decoded video as the video 111 to the video display unit 307. The process then proceeds to step S1503.

In step S1503 (detection step), the projection-distorted-position detection unit 304 calculates a tilt (angle) of the surfaces 1401 and 1402 of the projection object with respect to the projection direction (distortion information) by using the plane parameters and information on the projection direction of the projection device 105 in the same manner as in step S903 in FIG. 9. The process then proceeds to step S1504.

In step S1504 (detection step), the projection-distorted-position detection unit 304 compares the tilt of a surface with a threshold value to determine whether or not the projection will be distorted due to a surface tilt and outputs a result of the detection of projection distortion to the projection-distorted-position notifying unit 306 in the same manner as in step S904. The process then proceeds to step S1505.

In step S1505 (detection step), the projection-distorted-position detection unit 304 determines whether or not the projection will be distorted due to the edge.

Details of Step S1505

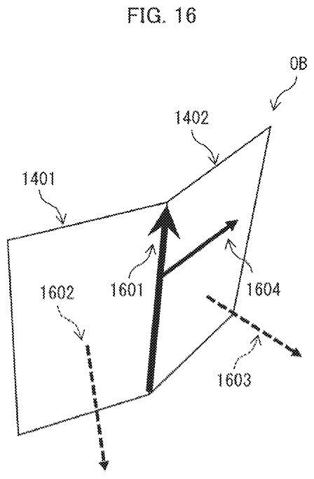

FIG. 16 illustrates step S1505. FIG. 16 is a perspective view of two of the three surfaces shown in FIG. 14 (surfaces 1401 and 1402).

A description is now given of step S1505. The projection-distorted-position detection unit 304 first acquires a vector 1601 that represents the edge connecting the surface 1401 to the surface 1402 in step S15051. The process then proceeds to step S15052.

In step S15052, the projection-distorted-position detection unit 304 acquires a normal vector 1602 of the surface 1401 and a normal vector 1603 of the surface 1402. The process then proceeds to step S15053.

In step S15053, the projection-distorted-position detection unit 304 calculates a cross product of the vector 1601 and the normal vector 1602 and acquires a binormal vector 1604. The binormal vector 1604 can be obtained from equation (8) below.

[Math. 8]

\vec{N_{sub}}=\vec{E}×\vec{N₃} (8)
where \vec{N_{sub}} is the binormal vector 1604, \vec{E} is the vector 1601 representing the edge, \vec{N₃} is the normal vector 1603, and “×” is a symbol for a cross product of vectors.

The process then proceeds to step S15054.

In step S15054, the projection-distorted-position detection unit 304 calculates a scalar product of the binormal vector 1604 and the normal vector 1603. The scalar product can be obtained from equation (9) below.

[Math. 9]

Sign(\vec{N_{sub}}·\vec{N₂}) (9)
where \vec{N_{sub}} is the binormal vector 1604, \vec{N₂} is the normal vector 1602, “sign” is a function of giving the sign of a result of evaluation of a mathematical expression, and “·” is an operator representing a scalar product of vectors.”

The process then proceeds to step S15055.

In step S15055, the projection-distorted-position detection unit 304 determines, on the basis of the value of the calculated scalar product, whether or not the projection will be distorted. Specifically, if the calculated scalar product has a value close to 0, the two surfaces 1401 and 1402 are substantially parallel, which leads to a small distortion. Therefore, the worker WR shown in FIG. 14 can accurately recognize the contents projected onto the surface 1401 and the surface 1402, in which case no particular notification is made. Meanwhile, if the calculated scalar product has a positive value, the edge connecting the surface 1401 to the surface 1402 forms a groove. If the calculated scalar product has a negative value, the edge connecting the surface 1401 to the surface 1402 forms a ridge. If it turns out from the value of the calculated scalar product that the edge connecting the surface 1401 to the surface 1402 forms a ridge, the projection-distorted-position detection unit 304 outputs, to the projection-distorted-position notifying unit 306, a result of the detection of projection distortion indicating that there may be a distortion, in other words, that the worker WR may not recognize the projection content. Specifically, the projection-distorted-position detection unit 304 outputs, to the projection-distorted-position notifying unit 306, a result of the detection of projection distortion indicating that the worker WR may not recognize the contents projected onto the surface 1401 which is adjacent to the surface 1402 located squarely opposite the worker WR, with an edge intervening between the surfaces 1401 and 1402.

In step S1506 (notification step), similarly to step S905 in FIG. 9, the projection-distorted-position notifying unit 306 draws the screen by superimposing notification contents at a corresponding position on the video 111 on the basis of the received result of the detection of projection distortion. The projection-distorted-position notifying unit 306 acquires a result of determination obtained in step S1504 and a result of determination obtained in step S15055. If either of the results indicates that the projection will be distorted, the projection-distorted-position notifying unit 306 needs only to draw the screen containing superimposed notification contents indicating that the projection will be distorted. The determination made on the basis of a surface tilt (step S1504) may be given a priority. Specifically, if it is determined on the basis of a surface tilt that neither the surface 1401 nor the surface 1402 will cause distortion, it may be the instructor that determines projection suitability.

Step S1507 and subsequent steps are the same as step S906 and subsequent steps in FIG. 9.

Software Implementation

The control unit 300 in the projection suitability detection system in accordance with the present disclosure may be implemented by logic circuits (hardware) fabricated, for example, in the form of an integrated circuit (IC chip) and may be implemented by software executed by a CPU.

In the latter form of implementation, the control unit 300 includes, among others: a CPU that executes instructions from programs (projection suitability detection program) or software by which various functions are implemented; a ROM (read-only memory) or like storage device (referred to as a “storage medium”) containing the programs and various data in a computer-readable (or CPU-readable) format; and a RAM (random access memory) into which the programs are loaded. The computer (or CPU) then retrieves and executes the programs contained in the storage medium, thereby achieving the object of the present disclosure. The storage medium may be a “non-transient, tangible medium” such as a tape, a disc, a card, a semiconductor memory, or programmable logic circuitry. The programs may be supplied to the computer via any transmission medium (e.g., over a communications network or by broadcasting waves) that can transmit the programs. The present disclosure, in an aspect thereof, encompasses data signals on a carrier wave that are generated during electronic transmission of the programs.

General Description

The present disclosure, in aspect 1 thereof, is directed to a projection suitability detection system including: a first terminal including an instruction device 109 (structure on the instruction room CS end including the instruction device 109) that receives designation of a position in a captured image of an object (operation target object OB); and a second terminal including a projection device 105 (structure on the worksite WS end including the worker-end device 108) that projects visual information 106′ (projection content 106) onto a projection surface of the object (surface of the operation target object OB), the projection surface corresponding to the designated position in the captured image, the first terminal and the second terminal being separated by such a distance that the first terminal and the second terminal can communicate with each other, the projection suitability detection system further including a detection unit (projection-distorted-position detection unit 304) that detects based on the captured image whether or not the projection surface causes projection distortion, wherein the first terminal (structure on the instruction room CS end including the instruction device 109) includes an output unit (projection-distorted-position notifying unit 306) that outputs a result of detection performed by the detection unit (projection-distorted-position detection unit 304).

This configuration can detect a location where visual information is not projected onto a projection surface in a suitable manner and notify a result of the detection to the instructor who specifies the visual information.

Specifically, in projecting visual information (projection content) on a projection surface, the configuration can detect, on the basis of the captured image, a location where the projection content appears partially distorted (location where the projection is distorted) to the user who is observing the projection surface on the second terminal end where the projection device is installed (worker WR) due to the different point-of-view directions of the users of the projection suitability detection system who reside respectively on the first terminal end and on the second terminal end. The configuration can also provide a projection suitability detection system that outputs (notifies) the presence of the location.

In aspect 2 of the present disclosure, the projection suitability detection system of aspect 1 may be configured such that the detection unit (projection-distorted-position detection unit 304) detects, based on positional correspondence between pixels in a reference image and pixels in the captured image which appears when the projection device 105 projects the reference image (patterned image) onto the projection surface, whether or not the projection surface causes projection distortion.

Since this configuration detects distortion based on positional correspondence between pixels in the captured image and pixels in the reference image, the projection suitability detection system can be used in an outdoor environment. Based on the positional correspondence, it is also possible to detect whether or not the projection will be distorted even in a location where the projection surface is flat and has extremely few topographical features like the top surface of the desk.

In aspect 3 of the present disclosure, the projection suitability detection system of aspect 1 or 2 may be configured such that the detection unit (projection-distorted-position detection unit 304) detects, based on an angle of the projection surface (surface of the operation target object OB) with respect to a projection direction of the projection device 105, whether or not the projection surface causes projection distortion.

If the projection surface is oblique to the projection direction of the projection device, the projected visual information appears distorted to the user of the projection suitability detection system who positions hisself/herself at right angles to the projection direction on the second terminal end. Accordingly, the configuration of aspect 3 detects a location where the projection is distorted, based on the angle of the projection surface from the projection direction of the projection device.

In aspect 4 of the present disclosure, the projection suitability detection system of any one of aspects 1 to 3 may be configured such that the output unit (the projection-distorted-position notifying unit 306) outputs (notifies) that the projection surface (surface of the operation target object OB) causes projection distortion, by (1) causing the instruction device 109 to display an image that differs from the visual information at the designated position in the captured image, (2) causing the instruction device 109 to display content (notification contents 602) at a position that differs from the designated position in the captured image, or (3) causing the instruction device 109 to vibrate.

In aspect 5 of the present disclosure, the projection suitability detection system of any one of aspects 1 to 4 may be configured such that the detection unit (projection-distorted-position detection unit 304) is provided in the first terminal (structure on the instruction room CS end including the instruction device 109).

The present disclosure, in aspect 6 thereof, is directed to a projection-end terminal separated from an instructor-end terminal by such a distance that the projection-end terminal can communicate with the instructor-end terminal, the instructor-end terminal including an instruction device 109 (structure on the instruction room CS end including the instruction device 109) that receives designation of a position in a captured image of an object (operation target object OB), the projection-end terminal including a projection device 105 (structure on the worksite WS end including the worker-end device 108) that projects visual information 106′ (projection content 106) onto a projection surface of the object (surface of the operation target object OB), the projection surface corresponding to the designated position in the captured image, the projection-end terminal including a detection unit (projection-distorted-position detection unit 304) that detects based on the captured image whether or not the projection surface causes projection distortion, wherein the instructor-end terminal (projection-distorted-position notifying unit 306) outputs a result of detection performed by the detection unit (projection-distorted-position detection unit 304).

The present disclosure, in aspect 7 thereof, is directed to an instructor-end terminal including an instruction device 109 (structure on the instruction room CS end including the instruction device 109) that receives designation of a position in a captured image of an object (operation target object OB), the instructor-end terminal being separated from a projection-end terminal by such a distance that the instructor-end terminal can communicate with the projection-end terminal, the projection-end terminal including a projection device 105 (structure on the worksite WS end including the worker-end device 108) that projects visual information 106′ (the projection content 106) onto a projection surface of the object (surface of the operation target object OB), the projection surface corresponding to the designated position in the captured image, the instructor-end terminal including: a detection unit (projection-distorted-position detection unit 304) that detects based on the captured image whether or not the projection surface causes projection distortion; and an output unit (projection-distorted-position notifying unit 306) that outputs a result of detection performed by the detection unit (projection-distorted-position detection unit 304).

The present disclosure, in aspect 8 thereof, is directed to a method of detecting projection suitability performed by a projection suitability detection system including: a first terminal including an instruction device 109 (structure on the instruction room CS end including the instruction device 109) that receives designation of a position in a captured image of an object (operation target object OB); and a second terminal including a projection device 105 (structure on the worksite WS end including the worker-end device 108) that projects visual information 106′ (projection content 106) onto a projection surface of the object (surface of the operation target object OB), the projection surface corresponding to the designated position in the captured image, the first terminal and the second terminal being separated by such a distance that the first terminal and the second terminal can communicate with each other, the method including: the detection step of detecting based on the captured image whether or not the projection surface causes projection distortion; and the output step of the first terminal (structure on the instruction room CS end including the instruction device 109) outputting a result of detection performed in the detection step.

These configurations achieve the same advantages as the projection suitability detection system described above.

The projection suitability detection system of any one of aspects 1 to 5 may be implemented on a computer, in which case the present disclosure encompasses a control program that causes a computer to function as the various units (software elements) of the projection suitability detection system, thereby implementing the units on the computer, and also encompasses a computer-readable storage medium containing the control program.

Additional Remarks

The present disclosure is not limited to the description of the embodiments above and may be altered within the scope of the claims. Embodiments based on a proper combination of technical means disclosed in different embodiments are encompassed in the technical scope of the present disclosure. Furthermore, a new technological feature can be created by combining different technological means disclosed in the embodiments.

### CROSS-REFERENCE TO RELATED APPLICATIONS

The present application claims the benefit of Japanese Patent Application, Tokugan, No. 2017-017061, filed in Japan on Feb. 1, 2017, the subject matter of which is incorporated herein by reference.

### REFERENCE SIGNS LIST

100 Projection Suitability Detection System
WS Worksite
CS Instruction Room
WR Worker
CR Instructor
OB Operation Target Object (Projection Surface of Object)
104 External Input Unit (First Terminal, Instructor-end Terminal)
105 Projection Device (Second Terminal, Projection-end Terminal)
106 Projection Content
106′ Visual Information
107 Image Capturing Device (Projection-end Terminal)
108 Worker-end Device (Projection-end Terminal)
109 Instruction Device (First Terminal, Instructor-end Terminal)
110 Display Device (First Terminal, Instructor-end Terminal)
111 Video
200 Managing Server
300 Control Unit (Control Device)
301 Video Acquisition Unit
302 Encoding Unit
303 Surface Inferring Unit
304 Projection-distorted-position Detection Unit (Detection Unit)
305 Decoding Unit
306 Projection-distorted-position Notifying Unit (Output Unit)
307 Video Display Unit
308 Input Receiving Unit
309 Projection Content Output Unit
401 First Communications Unit
402 First Storage Unit
403 First Control Unit
404 Second Communications Unit
405 Second Storage Unit
406 Second Control Unit
501 Corresponding-point-map Acquisition Unit
502 Group-of-points Acquisition Unit
503 Plane-parameter Deriving Unit
602 Notification Contents (Contents)
1003 Dent
1101 Projection Region
1102 Imaging Region
1103, 1104 Location for Which No Corresponding-point Map Is Acquired

1-9. (canceled)

10. A projection suitability detection system comprising:
a first terminal including an instruction device that receives designation of a position in a captured image of an object; and
a second terminal including a projection device that projects visual information onto a projection surface of the object, the projection surface corresponding to the designated position in the captured image,
the first terminal and the second terminal being separated by such a distance that the first terminal and the second terminal can communicate with each other,
the projection suitability detection system further comprising detection circuitry that detects based on the captured image whether or not the projection surface causes projection distortion,
wherein the first terminal includes output circuitry that outputs, via the instruction device, a result of detection performed by the detection circuitry.

11. The projection suitability detection system according to claim 10, wherein the detection circuitry detects, based on positional correspondence between pixels in a reference image and pixels in the captured image which is acquired when the projection device projects the reference image onto the projection surface, whether or not the projection surface causes projection distortion.

12. The projection suitability detection system according to claim 10, wherein the detection circuitry detects, based on an angle of the projection surface with respect to a projection direction of the projection device, whether or not the projection surface causes projection distortion.

13. The projection suitability detection system according to claim 10, wherein the output circuitry outputs the result of detection, which indicates that the projection surface causes projection distortion, by (1) causing the instruction device to display an image that differs from the visual information at the designated position in the captured image, (2) causing the instruction device to display content at a position that differs from the designated position in the captured image, or (3) causing the instruction device to vibrate.

14. The projection suitability detection system according to claim 10, wherein the detection circuitry is provided in the first terminal.

15. An instructor-end terminal including an instruction device that receives designation of a position in a captured image of an object,
the instructor-end terminal being separated from a projection-end terminal by such a distance that the instructor-end terminal can communicate with the projection-end terminal, the projection-end terminal including a projection device that projects visual information onto a projection surface of the object, the projection surface corresponding to the designated position in the captured image,
the instructor-end terminal comprising:
detection circuitry that detects based on the captured image whether or not the projection surface causes projection distortion; and
output circuitry that outputs, via the instruction device, a result of detection performed by the detection circuitry.

16. A method of detecting projection suitability performed by a projection suitability detection system including: a first terminal including an instruction device that receives designation of a position in a captured image of an object; and a second terminal including a projection device that projects visual information onto a projection surface of the object, the projection surface corresponding to the designated position in the captured image, the first terminal and the second terminal being separated by such a distance that the first terminal and the second terminal can communicate with each other, the method comprising:
a detection step of detecting based on the captured image whether or not the projection surface causes projection distortion; and
an output step of the first terminal outputting, via the instruction device, a result of detection performed in the detection step.

17. A non-transitory medium storing therein a projection suitability detection program for causing a computer to function as the projection suitability detection system according to claim 10, the projection suitability detection program causing the computer to function as each of the detection circuitry and the output circuitry.
